(19) United States
(12) Patent Application Publication
(10) Pub. No.: US 2025/0016498 A1
(43) Pub. Date: Jan. 9, 2025

(54) LOW NOISE PORT TUBE

(71) Applicant: Samsung Electronics Co., Ltd., Suwon-si (KR)

(72) Inventors: Andri Bezzola, La Canada, CA (US); Allan Devantier, Santa Paula, CA (US)

(21) Appl. No.: 18/803,319

(22) Filed: Aug. 13, 2024

Related U.S. Application Data
(63) Continuation-in-part of application No. 16/926,364, filed on Jul. 10, 2020, now abandoned.
(60) Provisional application No. 62/878,683, filed on Jul. 25, 2019.

(51) Int. Cl. H04R 1/30; G06F 30/20

(52) U.S. Cl. CPC H04R 1/30; G06F 30/20

(57) ABSTRACT

One embodiment provides a method that includes optimizing a shape for a port tube of a speaker device by varying a portion of multiple initial port tube design parameters and iteratively repeating an execution of a simulation computing process that simulates shear measure until the execution of the simulation computing process minimizes the simulated shear measure and outputs a final port tube design for an improved port tube having an optimized central portion and an optimized flare shape of at least one flared exit based on multiple final port tube design parameters for an improved shape for the port tube that maximally delays an onset of turbulence and flow separation for improved low frequency output for the speaker device. The improved port tube is generated using the multiple final port tube design parameters.

### CROSS-REFERENCE TO RELATED APPLICATIONS

This application is a Continuation-in-Part of U.S. patent application Ser. No. 16/926,364, filed on Jul. 10, 2020, which claims priority to U.S. Provisional Patent Application No. 62/878,683, filed on Jul. 25, 2019, both hereby incorporated by reference in their entirety.

### COPYRIGHT DISCLAIMER

A portion of the disclosure of this patent document may contain material that is subject to copyright protection. The copyright owner has no objection to the facsimile reproduction by anyone of the patent document or the patent disclosure as it appears in the patent and trademark office patent file or records, but otherwise reserves all copyright rights whatsoever.

### TECHNICAL FIELD

One or more embodiments relate generally to port tubes, and in particular, to predicting port tube shape that maximally delays the onset of turbulence and flow separation.

### BACKGROUND

Port tubes are used in loudspeakers to improve the low frequency output of a loudspeaker, such as to enhance the bass. The port tube creates a mass of air inside the port. The enclosure acts as a suspension for that mass of air. In principle, the air in the port and the air in the enclosure create a mass-spring (-damper) system, which can have a defined resonance. When this resonance is not tuned properly, then the resonating air of the port tube can create a poor low frequency output for the loudspeaker.

### SUMMARY

One embodiment provides a method that includes optimizing a shape for a port tube of a speaker device by varying a portion of multiple initial port tube design parameters and iteratively repeating an execution of a simulation computing process that simulates shear measure until the execution of the simulation computing process minimizes the simulated shear measure and outputs a final port tube design for an improved port tube having an optimized central portion and an optimized flare shape of at least one flared exit based on multiple final port tube design parameters for an improved shape for the port tube that maximally delays an onset of turbulence and flow separation for improved low frequency output for the speaker device. The improved port tube is generated using the multiple final port tube design parameters.

Another embodiment provides a non-transitory processor-readable medium that includes a program that when executed by a processor performs a method for optimizing a port tube design, by a computing process, the method including optimizing, by the processor, a shape for a port tube of a speaker device by varying a portion of multiple initial port tube design parameters and iteratively repeating an execution of a simulation computing process that simulates shear measure until the execution of the simulation computing process minimizes the simulated shear measure and outputs a final port tube design for an improved port tube having an optimized central portion and an optimized flare shape of at least one flared exit based on multiple final port tube design parameters for an improved shape for the port tube that maximally delays an onset of turbulence and flow separation for improved low frequency output for the speaker device. The improved port tube is generated using the multiple final port tube design parameters.

Still another embodiment provides a port tube for a loudspeaker that includes a body including at least one flared exit and an optimized central portion that is designed by optimization utilizing a simulation computing process for outputting multiple final port tube design parameters for the port tube. The port tube structure is based on the multiple final port tube design parameters from the simulation computing process that includes optimizing a shape for the port tube by varying a portion of multiple initial port tube design parameters and iteratively repeating execution of the simulation computing process that simulates shear measure until the execution of the simulation computing process minimizes the simulated shear measure and outputs a final port tube design for the port tube having the optimized central portion and an optimized flare shape of the at least one flared exit based on the multiple final port tube design parameters for an improved shape for the port tube that maximally delays an onset of turbulence and flow separation for improved low frequency output for the loudspeaker device.

These and other features, aspects and advantages of the one or more embodiments will become understood with reference to the following description, appended claims and accompanying figures.

### BRIEF DESCRIPTION OF THE DRAWINGS

FIG. 1 illustrates an example loudspeaker and enclosure including a straight port tube;

FIG. 2A illustrates an example straight port tube;

FIG. 2B illustrates an example port tube with flared exits;

FIG. 3 illustrates an image of sharp gradients in air velocity across the exits of a port tube;

FIG. 4 illustrates a graph showing air velocity difference from the center of a port to the edges of the port;

FIG. 5 illustrates an example simulated air flow separation;

FIG. 6A illustrates a three-dimensional (3-D) graph of sound spectra for an example loudspeaker including a non-optimal port design;

FIG. 6B illustrates a 3-D graph of sound spectra for an example loudspeaker including an optimal port design;

FIG. 7 illustrates a graph comparing different ports for noise versus input level;

FIG. 8 illustrates a block diagram for a process for optimizing port design parameters, according to some embodiments;

FIG. 9 illustrates an image of gradients in air velocity across the port, according to some embodiments;

FIG. 10 illustrates a graph of differences between local air velocity at a center of the port and at a port wall for the image of FIG. 9, according to some embodiments;

FIG. 11 illustrates an image of gradients in air velocity across the port that is under-flared, according to some embodiments;

FIG. 12 illustrates a graph of differences between local air velocity at a center of the port that is under-flared and at the port wall for the image of FIG. 11, according to some embodiments;

FIG. 13 illustrates an image of gradients in air velocity across the port that is optimal, according to some embodiments;

FIG. 14 illustrates a graph of differences between local air velocity at a center of the port that is optimal and at the port wall for the image of FIG. 13, according to some embodiments;

FIG. 15 illustrates an image of gradients in air velocity across the port that is over-flared, according to some embodiments;

FIG. 16 illustrates a graph of differences between local air velocity at a center of the port that is over-flared and at the port wall for the image of FIG. 15, according to some embodiments;

FIG. 17A illustrates an image of gradients in air velocity across the port that is under-flared showing flatness of the velocity contour line at the port exit, according to some embodiments;

FIG. 17B illustrates an image of gradients in air velocity across the port that is optimal showing flatness of the velocity contour line at the port exit, according to some embodiments;

FIG. 17C illustrates an image of gradients in air velocity across the port that is over-flared showing flatness of the velocity contour line at the port exit, according to some embodiments;

FIG. 18A illustrates a graph of normalized velocity vectors and port chord vectors across the port that is under-flared, according to some embodiments;

FIG. 18B illustrates a graph of normalized velocity vectors and port chord vectors across the port that is optimal, according to some embodiments;

FIG. 18C illustrates a graph of normalized velocity vectors and port chord vectors across the port that is over-flared, according to some embodiments;

FIG. 19 illustrates a block diagram for a reiterative process for optimizing port design parameters, according to some embodiments;

FIG. 20 is a high-level block diagram showing an information processing system comprising a computer system useful for implementing various disclosed embodiments;

FIGS. 21A-D illustrate examples of parameterizing port tube cross section, according to some embodiments; and

FIG. 22 illustrates an example of using optimized parameters for constructing the inner surface of a port tube, according to some embodiments.

### DETAILED DESCRIPTION

The following description is made for the purpose of illustrating the general principles of one or more embodiments and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

One embodiment provides a method including optimizing a shape for a port tube of a speaker device by varying a portion of multiple initial port tube design parameters and iteratively repeating an execution of a simulation computing process that simulates shear measure until the execution of the simulation computing process minimizes the simulated shear measure and outputs a final port tube design for an improved port tube having an optimized central portion and an optimized flare shape of at least one flared exit based on multiple final port tube design parameters for an improved shape for the port tube that maximally delays an onset of turbulence and flow separation for improved low frequency output for the speaker device. The improved port tube is generated using the multiple final port tube design parameters.

In some embodiments, the disclosed technology utilizes numerical simulation to predict more accurately the optimal port tube shape that maximally delays the onset of turbulence and flow separation. In some embodiments, the disclosed technology includes a port tube, as well as an approach for designing such a port tube, that can be used at higher sound levels before the effects of turbulence and flow separation become audible and objectionable by a listener. It is contemplated that there can be many variations associated with the disclosed technology.

For expository purposes, the terms “loudspeaker,” “loudspeaker device,” and “loudspeaker system” may be used interchangeably in this specification.

For expository purposes, the terms “port,” “port tube,” “port vents,” and “vent” may be used interchangeably in this specification.

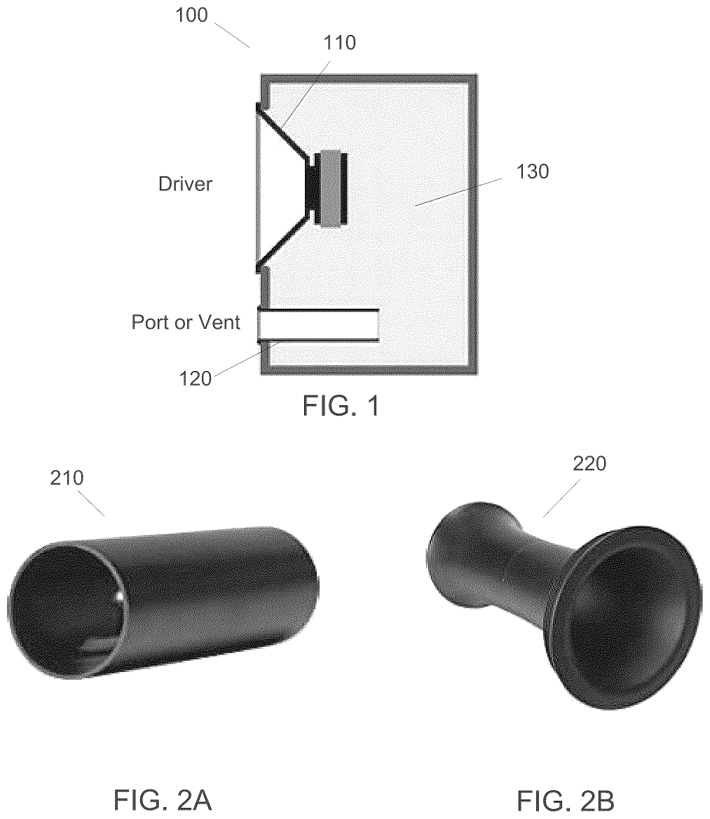

FIG. 1 illustrates an example loudspeaker 100 and enclosure 130 including a straight port tube 120. When the loudspeaker 100 receives an audio signal, the driver 110 moves, which causes air in the enclosure 130 to move through the exit of the port tube 120. Port tubes are used in loudspeakers to improve the low frequency output of a driver (e.g., driver 110), such as to enhance the bass. The port tube 120 creates a mass of air internally. The enclosure 130 acts as a suspension for that mass of air. In principle, the air in the port tube 120 and the air in the enclosure 130 create a mass-spring (-damper) system, which can have a defined resonance. When this resonance is tuned properly, then the resonating air of the port tube 120 can create an improved low frequency output for the loudspeaker 100, especially compared to a sealed box type loudspeaker.

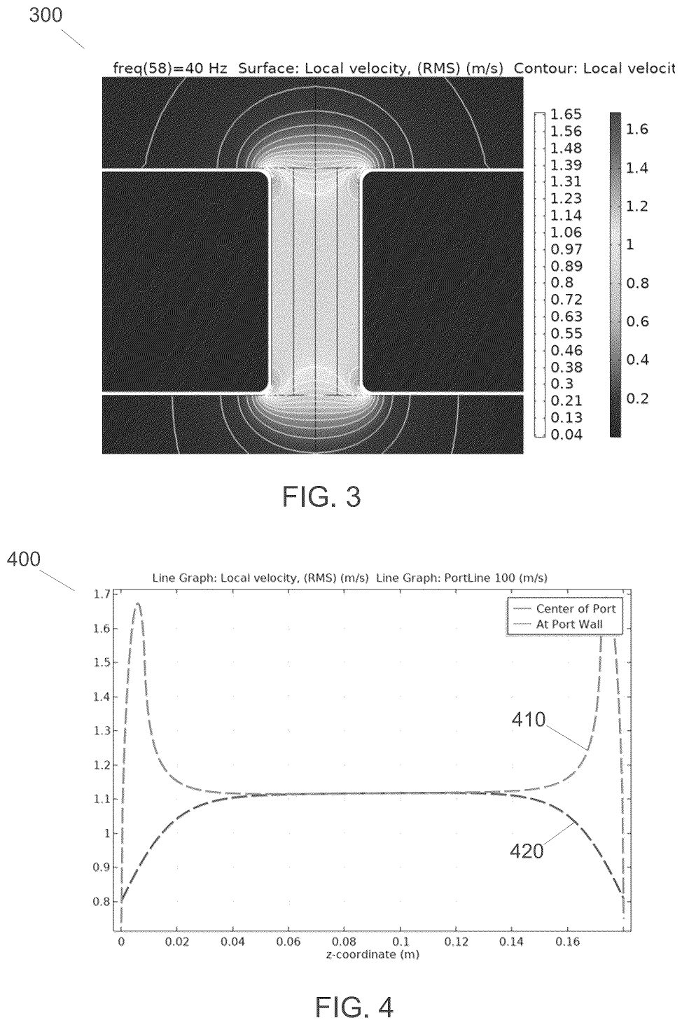

FIG. 2A illustrates an example straight port tube 210. FIG. 2B illustrates an example port tube 220 with flared exits. At higher sound pressure levels, the air in a loudspeaker port or vent moves at higher velocities, which can introduce unwanted effects such as turbulence and flow separation. These effects become audible as a degradation of the sound. Better port tubes are therefore designed with a more “aerodynamic” profile (e.g., narrow at center and flaring towards the ends) to avoid or delay the onset of turbulence and flow separation. The amount of flare rate for an optimal port has not been clearly defined. Therefore, loudspeaker designers often need to create several port tube prototypes to determine the optimal flare rate and shape of the ports.

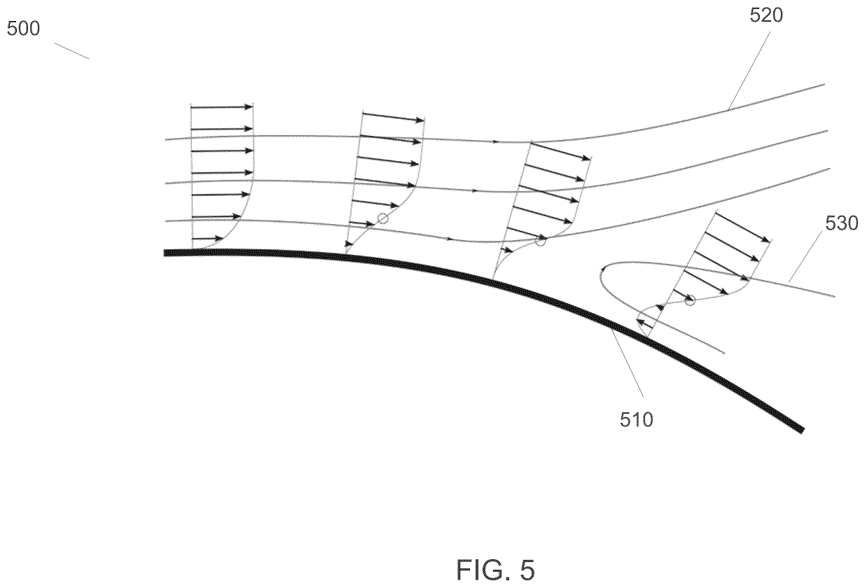

FIG. 3 illustrates an image 300 of sharp gradients in air velocity across the exits of the port tube. In some cases, flow separation can occur when the curvature of flow exceeds a certain limit.

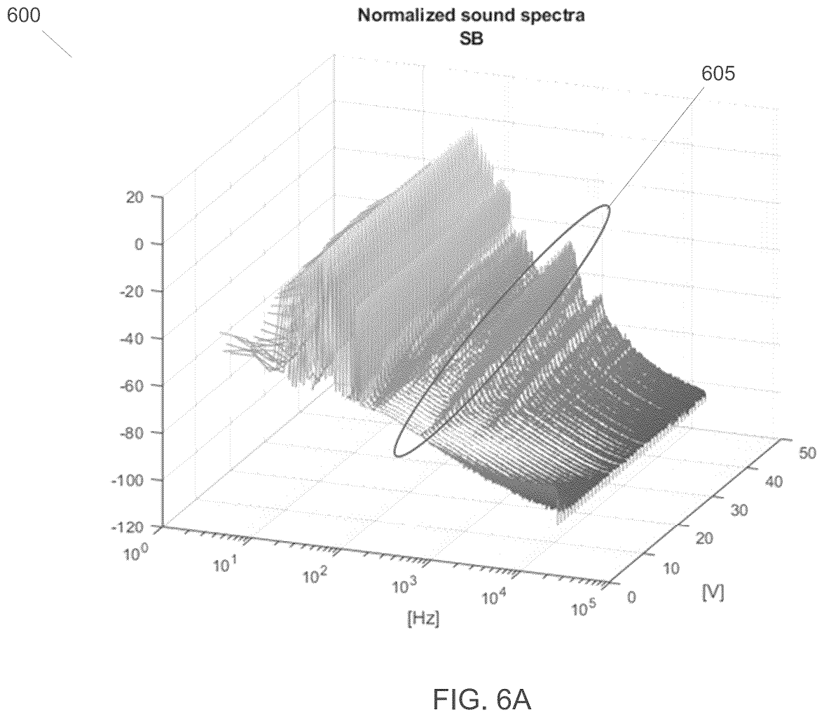

FIG. 4 illustrates a graph 400 showing air velocity difference from the center of a port 420 to the edges (walls) of the port 410.

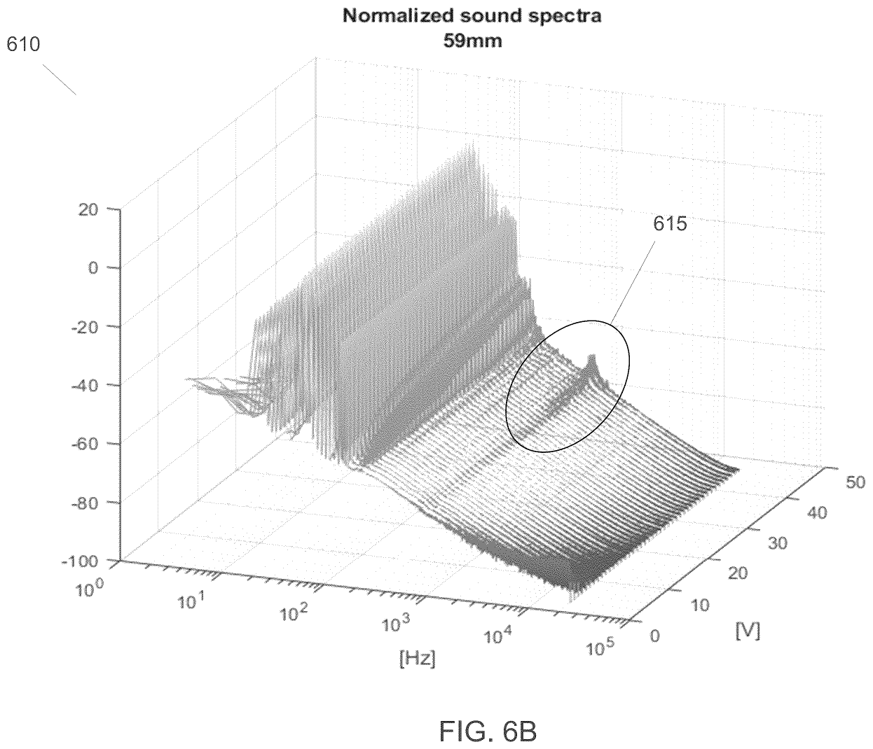

FIG. 5 illustrates an example 500 simulated air flow separation. Flow reversal can primarily be caused by adverse pressure gradient imposed on the boundary layer. The streamwise momentum equation inside the boundary layer can be stated as:

$$u \frac{\partial u}{\partial s} = - \frac{1}{p} \frac{dp}{ds} + v \frac{{\partial }^{2} u}{\partial {y}^{2}}$$

where s and y are streamwise and normal coordinates. An adverse pressure gradient is when shear stress

$$\frac{\partial p}{\partial s} > 0 ,$$

which can be seen to cause the velocity u to decrease along s and possibly go to zero if the adverse pressure gradient is strong enough. The air flow directions 520 and 530 can be seen to follow the vectors before the flare of a port 510, and deviate entering and exiting the flare of the port 510. In some cases, when flow separation happens, then the air in a port gets excited with an impulse-like pressure perturbation as the vortices are shed. This perturbation excites the natural resonances in the port itself (eigenmodes of air in port only). The natural frequencies become clearly audible, even if they are not contained in the source material (e.g., music, etc.), and can be measured with standard audio measurement equipment.

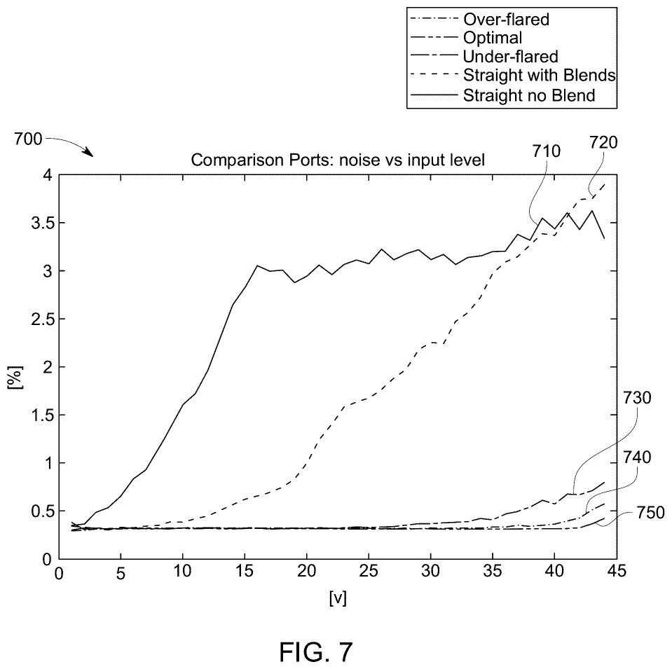

FIG. 6A illustrates a three-dimensional (3-D) graph 600 of sound spectra for an example loudspeaker including a non-optimal port design at different driving levels. FIG. 6B illustrates a 3-D graph 610 of sound spectra for an example loudspeaker including an optimal port design at different driving levels. In both graphs 600 and 610, the example loudspeaker is excited with a signal containing frequencies from 20 Hz to 160 Hz. The output at 750 Hz becomes clearly evident (oval 605). With an optimized port, the artifact around 750 Hz (oval 615) only becomes evident at high driving voltages of 30 or more volts.

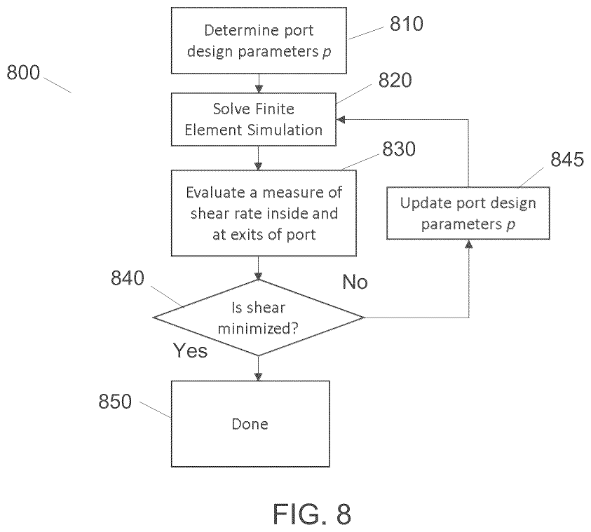

FIG. 7 illustrates a graph 700 comparing different ports for noise versus input level. Graph 700 shows the power spectral content of the band between 700 Hz and 1200 Hz compared to the total power spectrum on the y-axis. On the x-axis of graph 700 is the drive level. In graph 700, the compared ports are as follows: curve 710 represents a port tube that is straight with no blend, curve 720 represents a port tube that is straight with blends, curve 730 represents a port tube that is under-flared, curve 740 represents a port tube that is over-flared, and curve 750 represents a port tube that is optimal. The above example plot shows clearly that there is an optimal amount of flare. Compared to the straight ports (e.g., straight or straight with small blends at end), the flared ports perform much better. In some embodiments, the disclosed technology provides optimized ports based on avoiding pressure inversion along the port tube boundaries and transition to baffle. This means that the shear stress rate

$$\frac{\partial p}{\partial s}$$

is to be minimized. In some embodiments, predictions of pressure and pressure gradients can be made efficiently with linear numerical simulations. Ports with minimal shear stress at low levels where linear simulations are valid, are able to be played at higher levels before flow separation occurs. Designing a port tube then becomes an optimization process where a measure of shear stress can be minimized by varying some port tube shape parameters.

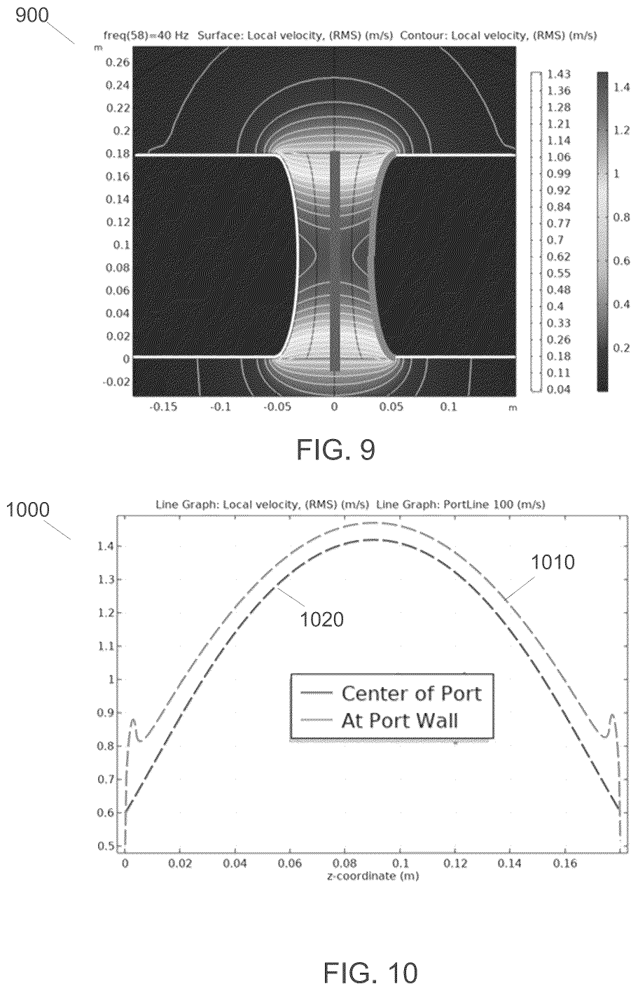

FIG. 8 illustrates a block diagram for a process 800 for optimizing port design parameters, according to some embodiments. In some embodiments, in block 810 process 800 determines port design parameters p. In some embodiments, port parameters p are parameters that define the shape of the port tube. The port parameters p can include port length, minimal cross sectional area, flare rate, maximal cross sectional area, parametrization (e.g., spline, parabolic, elliptical, exponential, polynomial, Bezier-curves, piece-wise parabolic, piece-wise quadratic, piece-wise polynomial, etc.), etc. In block 820, process 800 solves a numerical simulation (e.g., a finite element simulation, etc.). In some embodiments, when the numerical simulation is a finite element simulation, the finite element simulation solves partial differential equations in two or three space variables. The finite element simulation subdivides a large system into smaller, simpler parts that are referred to as finite elements. A particular space discretization in the space dimensions can be implemented by a construction of a mesh of the port: the numerical domain for the solution, which has a finite number of points. The finite element simulation of a boundary value problem results in a system of algebraic equations and approximates the unknown function over the domain. In some embodiments, the finite element simulation can be run to numerically solve the Helmholtz equation for acoustic waves, which can be performed in two-dimension (2D), 2D axisymmetric, or 3D, depending on the problem. The Helmholtz equation is referred to as an eigenvalue problem for the Laplace operator and is associated with the linear partial differential equation: where is the Laplacian, is the eigenvalue, and is the (eigen) function (represents the amplitude).

In some embodiments, in block 830 process 800 evaluates a measure of shear rate inside and at exits of the port. In some embodiments, in a post-processing step, a measure of shear can be determined based on the results of the numerical simulation in block 820. In block 840, it is determined if the shear is minimized or not. In some embodiments, if the shear is minimal, then the optimal solution is determined and process 800 ends at block 850. Otherwise, in block 845 the parameters p are updated and process 800 proceeds back to block 820. The parameters p can be iteratively updated in order to determine the optimal solution. A suitable optimization algorithm can be used to efficiently update the parameters p to find the optimal solution faster.

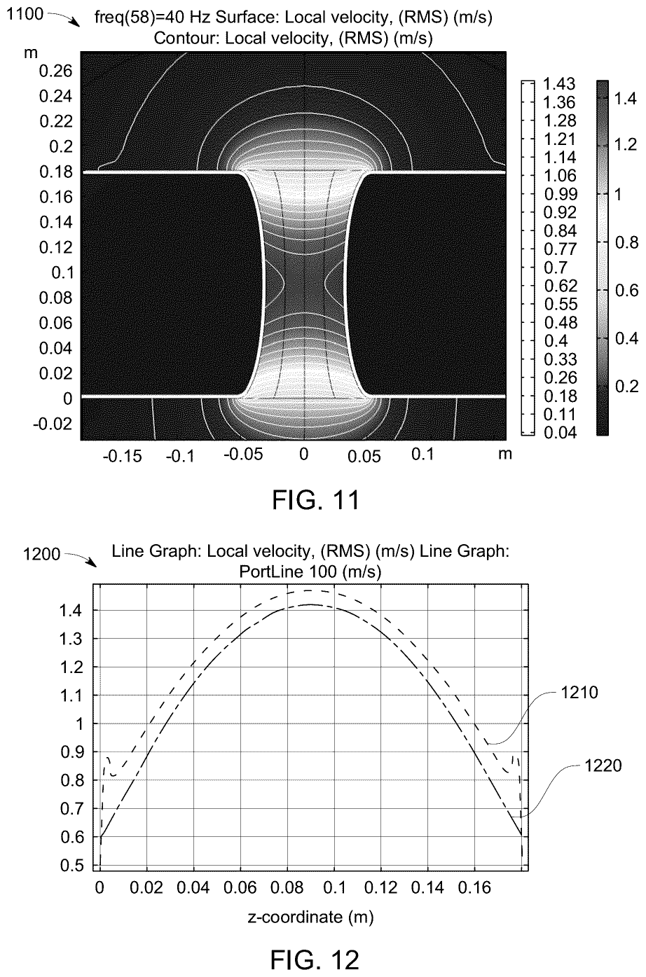

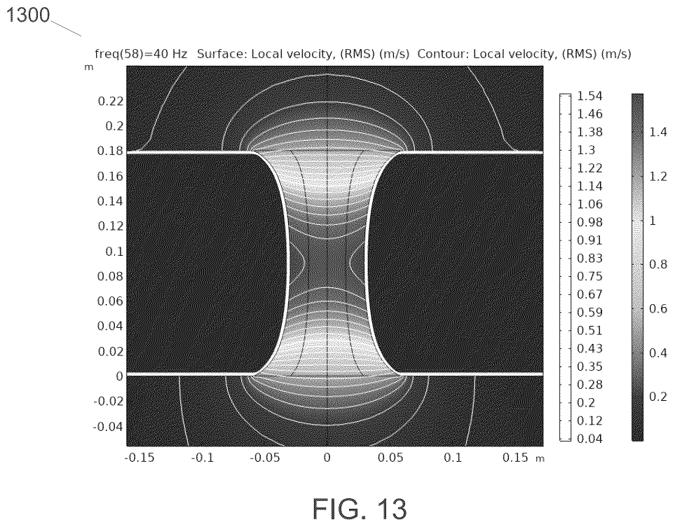

FIG. 9 illustrates an image 900 of gradients in air velocity across the port, according to some embodiments. In some implementations, an embodiment can specify the measure of shear as the difference δ between the air velocity at the center of the port v_{center} and the air velocity near the walls of the port v_{wall}. In order to minimize shear, the graphs (see, e.g., graph 1000, FIG. 10) of the air velocities at the two locations are to be as parallel as possible. By minimizing the variance Λ, a measure of shear in the port can be defined as:

$$min : Λ = {\int }_{0}^{{L}_{port}} {( δ - \overline{δ} )}^{2} ds \\ with \\ δ = {v}_{wall} - {v}_{center} .$$

In some embodiments, a port with lowest shear stress stays unseparated for highest port output level. FIG. 10 illustrates a graph 1000 of differences between a first curve 1020 of local air velocity at a center of the port tube and a second curve 1010 at a port tube wall for the image 900 of FIG. 9, according to some embodiments.

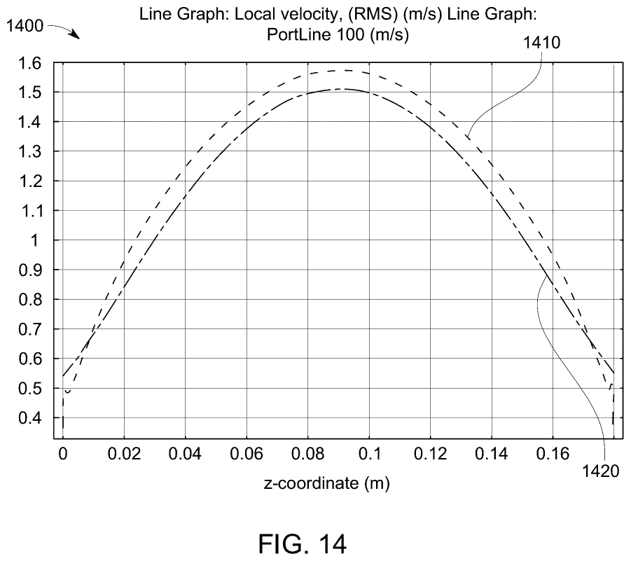

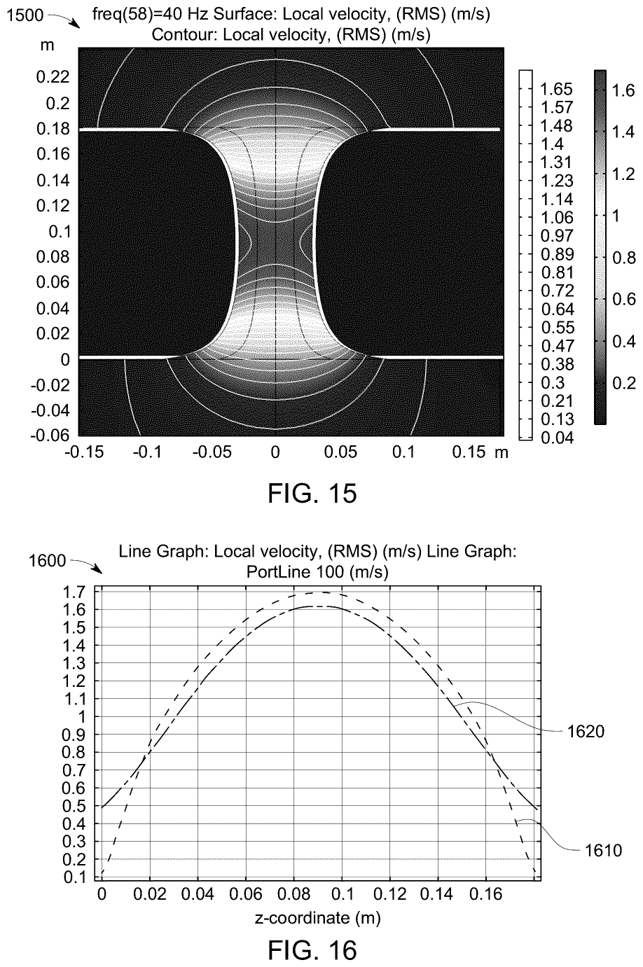

FIG. 11 illustrates an image 1100 of gradients in air velocity across the port that is under-flared, according to some embodiments. FIG. 12 illustrates a graph 1200 of differences between a first curve 1220 of local air velocity at a center of the port that is under-flared and a second curve 1210 at the port wall for the image 1100 of FIG. 11, according to some embodiments. As shown, the two curves 1210/1220 diverge from being parallel at the lower and upper ends of the z-coordinate, and separate before intersecting for a port design that is just under-flared.

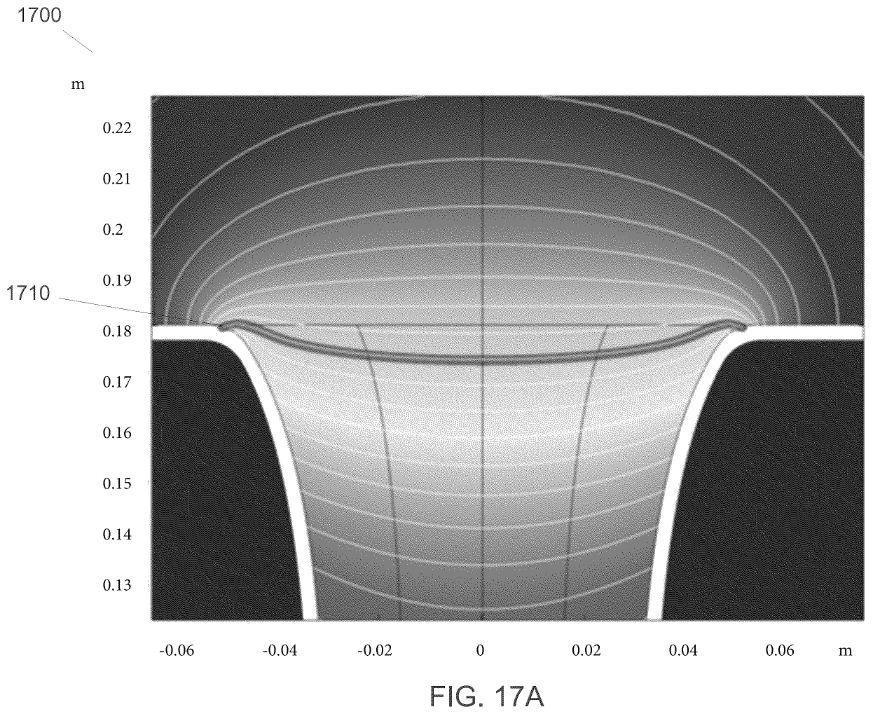

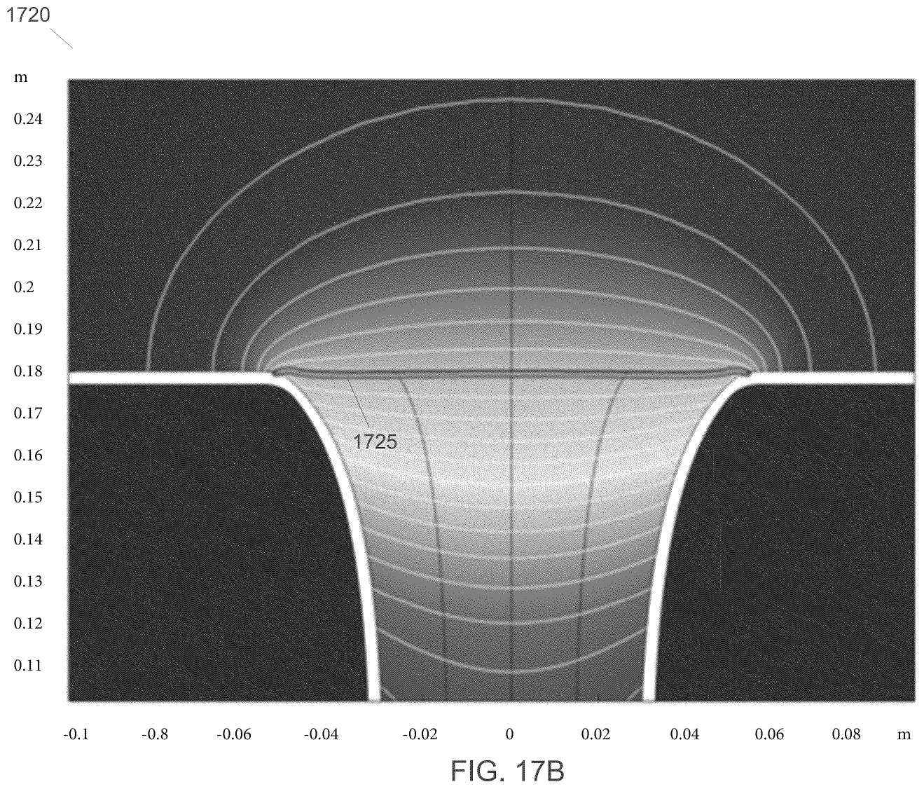

FIG. 13 illustrates an image 1300 of gradients in air velocity across the port that is optimal, according to some embodiments. FIG. 14 illustrates a graph 1400 of differences between a first curve 1420 of local air velocity at a center of the port tube that is optimal and a second curve 1410 at the port wall for the image 1300 of FIG. 13, according to some embodiments. As shown, the two curves 1410/1420 remain being parallel between the points that the two curves 1410/1420 intersect for a port design that is optimal.

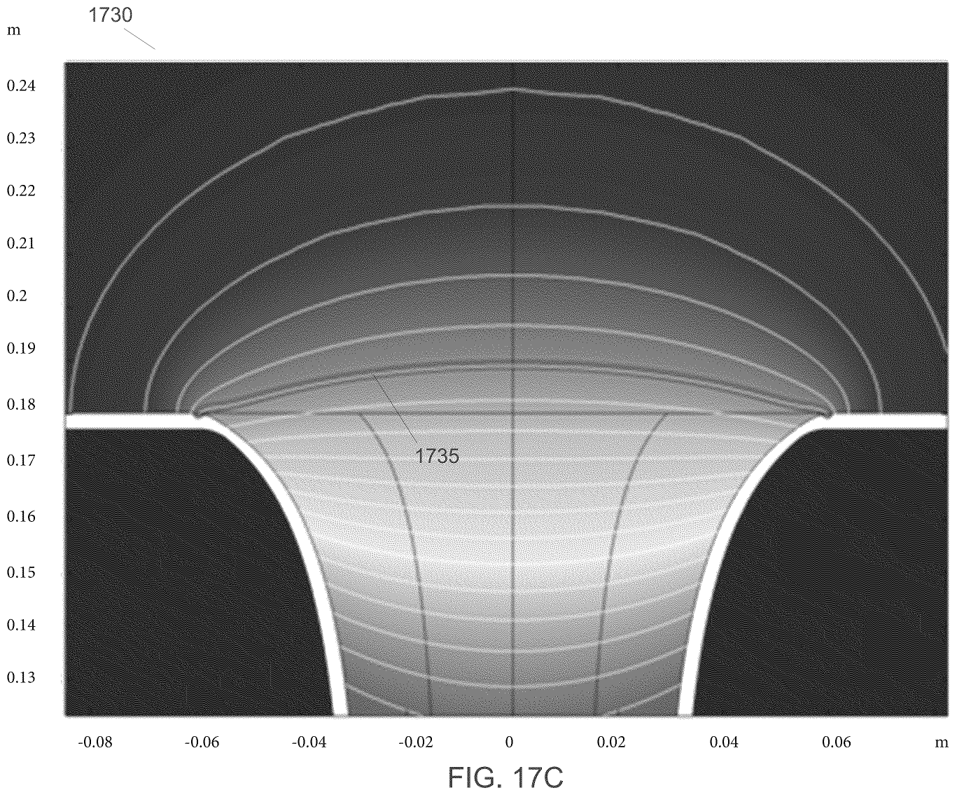

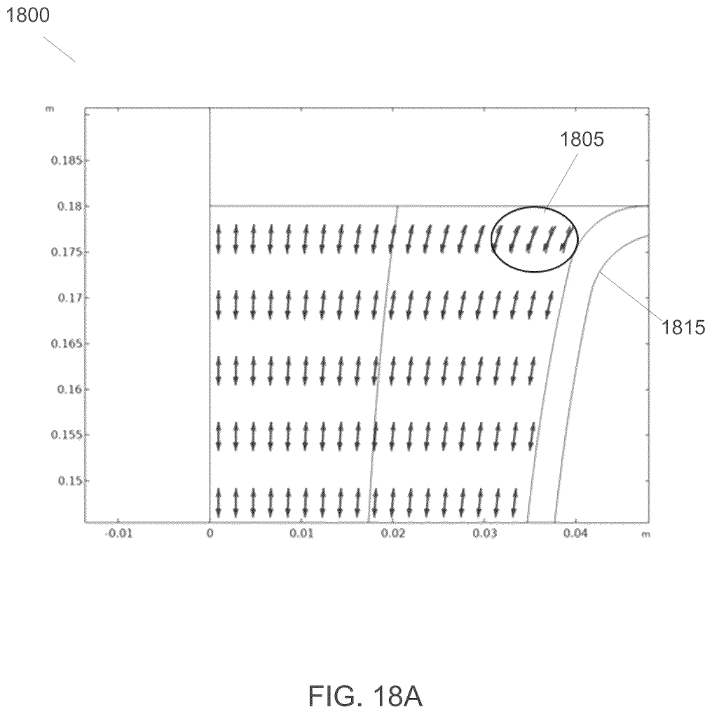

FIG. 15 illustrates an image 1500 of gradients in air velocity across the port that is over-flared, according to some embodiments. FIG. 16 illustrates a graph 1600 of differences between a first curve 1620 of local air velocity at a center of the port tube that is over-flared and a second curve 1610 at the port tube wall for the image 1500 of FIG. 15, according to some embodiments. As shown, the two curves 1610/1620 remain being parallel between the points that the two curves 1610/1620 intersect for a port design that is over-flared.

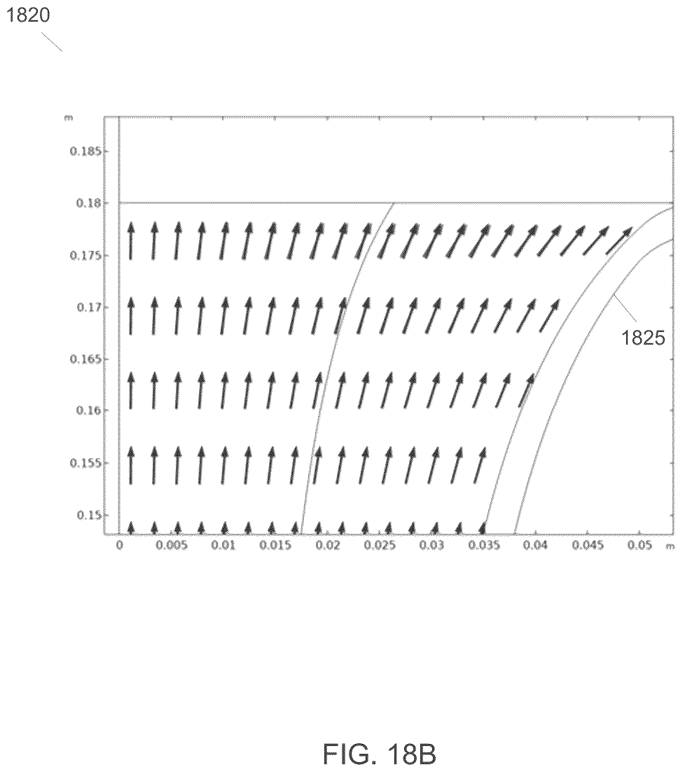

FIG. 17A illustrates an image 1700 of gradients in air velocity across a port that is under-flared showing flatness of the velocity contour line 1710 at the port exit, according to some embodiments. In some implementations, the measure of shear is determined as “flatness” of the velocity contour line at the port exit. A port with a “flatter” velocity contour at the port exit can have less shear and less propensity for exhibiting flow separation due to shear stresses. In some embodiments, the contour line 1710 is concave (or curves inward) showing the port being under-flared. In some embodiments, using the process for block diagram 800 (FIG. 8), the measure of flatness can be used to adjust the port parameters p to flatten out the velocity contour line at the port exit to optimize the port design.

FIG. 17B illustrates an image 1720 of gradients in air velocity across the port that is optimal showing flatness of the velocity contour line 1725 at the port exit, according to some embodiments. In some embodiments, the contour line 1725 is near flat showing the port being optimal.

FIG. 17C illustrates an image 1730 of gradients in air velocity across the port that is over-flared showing flatness of the velocity contour line 1735 at the port exit, according to some embodiments. In some embodiments, the contour line 1735 is convex (or curves outward) showing the port being over-flared.

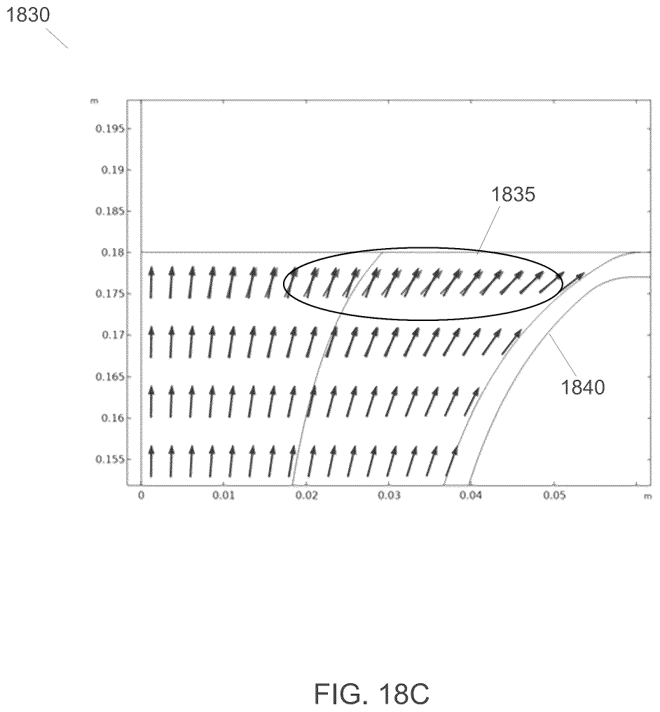

FIG. 18A illustrates a graph 1800 of normalized velocity vectors and port chord vectors across the port 1815 that is under-flared, according to some embodiments. In some implementations, an embodiment can specify the measure of shear based on “how parallel port chords and velocity vectors are” to one another. A port can be divided into several chords by splitting the port proportionately along the radial coordinate to produce “chords.” A port has minimal shear and propensity for flow separation when the velocity vectors in the port are as parallel as possible to the port chords. In graph 1800, the normalized velocity vectors and port chord vectors across the port 1815 within the oval 1805 are not aligned in parallel to one another. Rather, the normalized velocity vectors are angled more to the left as compared to the port chord vectors across the port 1815 within the oval 1805, which means the port 1815 design is under-flared for its port parameters p.

FIG. 18B illustrates a graph 1820 of normalized velocity vectors and port chord vectors across the port 1825 that is optimal, according to some embodiments. In graph 1820, the normalized velocity vectors and port chord vectors across the port 1825 are aligned in parallel to one another, which means the port 1825 design is optimal for its port parameters p.

FIG. 18C illustrates a graph 1830 of normalized velocity vectors and port chord vectors across the port 1840 that is over-flared, according to some embodiments. In graph 1830, the normalized velocity vectors and port chord vectors across the port 1840 within the oval 1835 are not aligned in parallel to one another. Rather, the normalized velocity vectors are angled more to the right as compared to the port chord vectors across the port 1840 within the oval 1835, which means the port 1840 design is over-flared for its port parameters p.

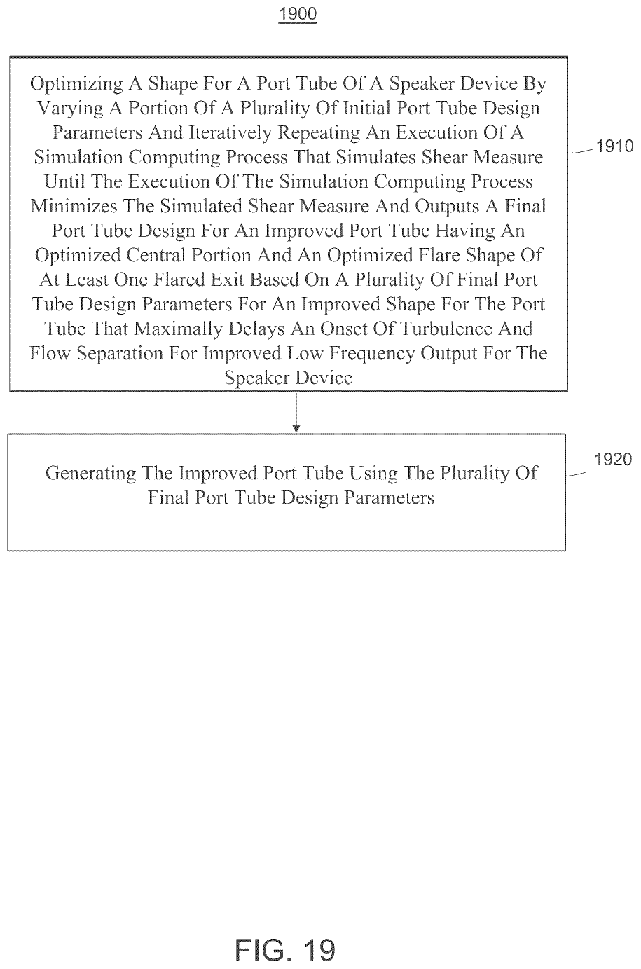

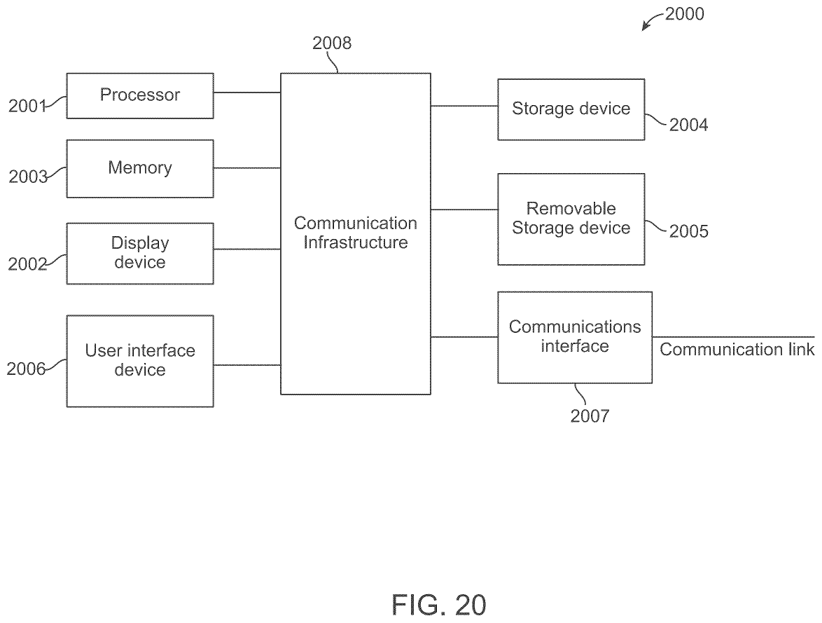

FIG. 19 illustrates a block diagram for a reiterative process 1900 for optimizing port tube design parameters, according to some embodiments. In some embodiments, in block 1910 process 1900 receives, by a processor (e.g., processor 2001, FIG. 20), port tube design parameters for a port tube for a speaker device (e.g., for a television, a sound bar, a subwoofer, etc.). In block 1920, process 1900 predicts, by the processor, pressure and pressure gradients by performing a numerical simulation process (e.g., process 800, FIG. 8) based on the port tube design parameters. In block 1930 process 1900 determines, by the processor, a measure of shear within the port tube and at exits of the port tube based on the predicted pressure and pressure gradients. In block 1940, process 1900 updates, by the processor, the port tube design parameters, and repeats (e.g., iteratively) performing the numerical simulation and the determining of the measure of shear until a minimized shear measure result is determined.

In one or more embodiments, process 1900 may include optimizing a shape for a port tube of a speaker device by varying a portion of multiple initial port tube design parameters and iteratively repeating an execution of a simulation computing process that simulates shear measure until the execution of the simulation computing process minimizes the simulated shear measure and outputs a final port tube design for an improved port tube having an optimized central portion and an optimized flare shape of at least one flared exit based on multiple final port tube design parameters for an improved shape for the port tube that maximally delays an onset of turbulence and flow separation for improved low frequency output for the speaker device. Process 1900 further provides for generating the improved port tube using the multiple final port tube design parameters.

In some embodiments, process 1900 may include the feature that the port tube design parameters define a shape of the port tube. Process 1900 may additionally include the feature that the port tube design parameters include one or more of port length, minimal cross-sectional area, flare rate, maximal cross-sectional area, or parameterization (e.g., spline, parabolic, elliptical, exponential, polynomial, Bezier-curves, piece-wise parabolic, piece-wise quadratic, piece-wise polynomial, etc.).

In one or more embodiments, process 1900 may include the feature that the measure of shear is based on determining a difference between at least two points between a graph of air velocities at a center of the port tube and a graph of air velocities adjacent walls of the port tube (e.g., differences between the graph or curve of air velocities at a center of the port tube and a graph or curve of air velocities adjacent walls of the port tube).

In some embodiments, process 1900 may further include the feature that the measure of shear is based on determining flatness of a velocity contour line at an exit of the port tube (see, e.g., FIGS. 17A-C).

In one or more embodiments, process 1900 may still further include the feature that the measure of shear is based on determining parallelism between determined port chords and determined velocity vectors (see, e.g., FIGS. 18A-C).

In some embodiments, process 1900 may include the feature that the updated parameters for the minimized shear measure result determine an optimized flare design shape for the port tube.

FIG. 20 is a high-level block diagram showing an information processing system comprising a computer system 2000 useful for implementing various disclosed embodiments. The computer system 2000 includes one or more processors 2001, and can further include an electronic display device 2002 (for displaying video, graphics, text, and other data), a main memory 2003 (e.g., random access memory (RAM)), storage device 2004 (e.g., hard disk drive), removable storage device 2005 (e.g., removable storage drive, removable memory module, a magnetic tape drive, optical disk drive, computer readable medium having stored therein computer software and/or data), user interface device 2006 (e.g., keyboard, touch screen, keypad, pointing device), and a communication interface 2007 (e.g., modem, a network interface (such as an Ethernet card), a communications port, or a PCMCIA slot and card).

The communication interface 2007 allows software and data to be transferred between the computer system 2000 and external devices. The computer system 2000 further includes a communications infrastructure 2008 (e.g., a communications bus, cross-over bar, or network) to which the aforementioned devices/modules 2001 through 2007 are connected.

Information transferred via the communications interface 2007 may be in the form of signals such as electronic, electromagnetic, optical, or other signals capable of being received by communications interface 2007, via a communication link that carries signals and may be implemented using wire or cable, fiber optics, a phone line, a cellular phone link, a radio frequency (RF) link, and/or other communication channels. Computer program instructions representing the block diagrams and/or flowcharts herein may be loaded onto a computer, programmable data processing apparatus, or processing devices to cause a series of operations performed thereon to produce a computer implemented process. In one embodiment, processing instructions for process 800 (FIG. 8) and/or process 1900 (FIG. 19) may be stored as program instructions on the memory 2003, storage device 2004, and/or the removable storage device 2005 for execution by the processor(s) 2001.

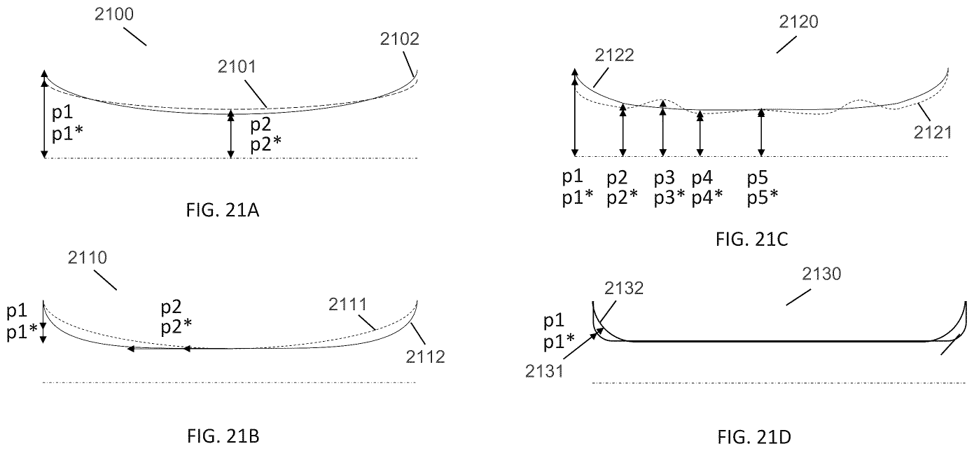

FIGS. 21A-D illustrate examples of parameterizing port tube cross section, according to some embodiments. The examples show how a port tube cross section can be parameterized with parameters pi and pi* that denotes the parameter values after optimization, where i is an integer. In example 2100 of FIG. 21A, a half-ellipse is used and the center and exit radii are defined. Curve 2101 represents the cross section with initial guesses of the parameters shown as p1, p2. Curve 2102 represents the cross section after optimization with p1* and p2* being the parameters after optimization. In example 2110 of FIG. 21B, a Bezier curve is used and the weights of the tangents at the port exit and the port center are optimized. Curve 2111 represents the cross section with initial guesses of the parameters shown as p1, p2. Curve 2112 represents the cross section after optimization with p1* and p2* being the parameters after optimization. In example 2120 of FIG. 21C, a spline curve and define several radii at predefined points along the centerline. Curve 2121 represents the cross section with initial guesses of the parameters shown as p1, p2, p3, p4 and p5. Curve 2122 represents the cross section after optimization with p1*, p2*, p3*, p4* and p5* being the parameters after optimization. In example 2130 of FIG. 21D, a corner blend is used, and the blend radius is defined. Curve 2131 represents the cross section with initial guesses of the parameter shown as p1. Curve 2132 represents the cross section after optimization with p1* being the parameter after optimization. It should be noted that these examples are not extensive, and they can also be combined to more complicated parametrizations.

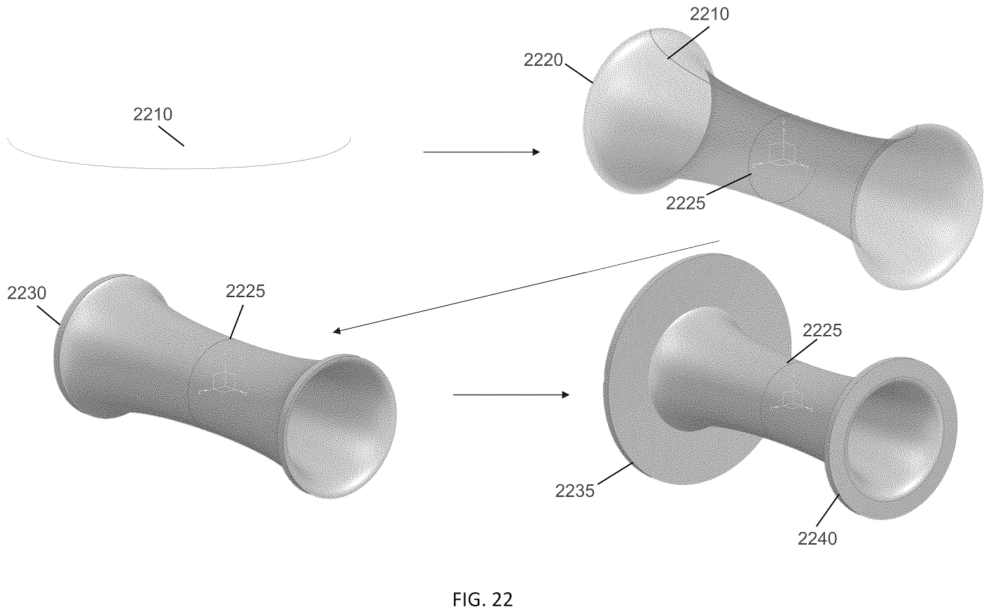

FIG. 22 illustrates an example of using optimized parameters (e.g., from examples 2100, 2110, 2120, 2130, (FIGS. 21A-D), etc.) for constructing the inner surface of a port tube, according to some embodiments. Once the optimal parameters pi* are found, the optimal cross section 2210 is defined for a port tube 2220. This cross section 2210 can then be revolved to construct the inner surface 2225 of the port tube 2220. The inner surface 2225 can then be thickened to the desired wall thickness to construct a solid object 2230. Finally, mounting flanges (2235, 2240) and other details can be added to the port design and final information (e.g., parameters) may be used for generating or manufacturing the desired and optimized port tube.

In some embodiments, once the multiple final port tube design information or parameters are optimized, the final design of the port tube may be generated as follows. In one or more embodiments, the optimized information or parameters define the cross section shape of the desired port tube. Next, in some embodiments a computer-aided design (CAD) software tool may be utilized (e.g., SOLIDWORKS®, NX®, CATIA®, ProE, 3D modeling tools, etc.), to refine, adjust, create and manipulate the 3D shape. In one or more embodiments, the shape is modified as required to ensure it meets manufacturing requirements, such as tolerances, material constraints, and assembly considerations. The acquired 3D shape information is then exported and utilized in a suitable format (e.g., stercolithography (STL), OBJ, PARASOLID®, initial graphics exchange specification (IGES), STEP, etc.) for use in computer-aided manufacturing (CAM) systems, 3D printing, etc.

In some embodiments, for generating a mold for an optimized port tube, the following may be implemented according to some embodiments. A CAD model is created where the mold geometry is designed using CAD software, including the main mold, thin mold top, and mold cap. Assembly features are utilized to position the mold components relative to each other. When meshing the mold, large edge lengths are assigned to the external boundary, while edge lengths on the internal boundary match the part edge length more closely. The mold is then determined to be generated as a CAD mold block or as regions. Creating a CAD mold block may take slightly longer, but it is recommended if the CAD model is clean and free of errors. Otherwise, generating the mold as regions and then adjusting the dimensions may be performed. The mold dimensions are verified, and adjustments are made as necessary before proceeding. Independent of the port shape optimization that can use a Finite Element Method (FEM) analysis, a mold mesh may be prepared by creating a CAD mold block around the CAD part, inserts, cooling channels, etc., and the system is fed using a tool for modeling a cuboid CAD mold or outer surface around the model. Once the mold is designed, the mold may be generated using known techniques. The generated mold can then be utilized for forming the optimized port tube in manufacturing.

Embodiments have been described with reference to flowchart illustrations and/or block diagrams of methods, apparatus (systems), and computer program products. In some cases, each block of such illustrations/diagrams, or combinations thereof, can be implemented by computer program instructions. The computer program instructions when provided to a processor produce a machine, such that the instructions, which executed via the processor create means for implementing the functions/operations specified in the flowchart and/or block diagram. Each block in the flowchart/block diagrams may represent a hardware and/or software module or logic. In alternative implementations, the functions noted in the blocks may occur out of the order noted in the figures, concurrently, etc.

The terms “computer program medium,” “computer usable medium,” “computer readable medium,” and “computer program product,” are used to generally refer to media such as main memory, secondary memory, removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Computer program instructions may be stored in a computer readable medium that can direct a computer, other programmable data processing apparatuses, or other devices to function in a particular manner, such that the instructions stored in the computer readable medium produce an article of manufacture including instructions which implement the function/act specified in the flowchart and/or block diagram block(s).

As will be appreciated by one skilled in the art, aspects of the embodiments may be embodied as a system, method or computer program product. Accordingly, aspects of the embodiments may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the embodiments may take the form of a computer program product embodied in one or more computer readable medium(s) having computer readable program code embodied thereon.

Any combination of one or more computer readable medium(s) may be utilized. The computer readable medium may be a computer readable storage medium (e.g., a non-transitory computer readable storage medium). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code for carrying out operations for aspects of one or more embodiments may be written in any combination of one or more programming languages, including an object oriented programming language such as Java, Smalltalk, C++, or the like, and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

In some cases, aspects of one or more embodiments are described above with reference to flowchart illustrations and/or block diagrams of methods, apparatuses (systems), and computer program products. In some instances, it will be understood that each block of the flowchart illustrations and/or block diagrams, and combinations of blocks in the flowchart illustrations and/or block diagrams, can be implemented by computer program instructions. These computer program instructions may be provided to a special purpose computer, or other programmable data processing apparatus to produce a machine, such that the instructions, which execute via the processor of the computer or other programmable data processing apparatus, create means for implementing the functions/acts specified in the flowchart and/or block diagram block(s).

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block(s).

The computer program instructions may also be loaded onto a computer, other programmable data processing apparatuses, or other devices to cause a series of operational steps to be performed on the computer, other programmable apparatuses, or other devices to produce a computer implemented process such that the instructions which execute on the computer or other programmable apparatuses provide processes for implementing the functions/acts specified in the flowchart and/or block diagram block(s).

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of pre-AIA 35 U.S.C. section 112, sixth paragraph, unless the element is expressly recited using the phrase “means for” or “step for.”

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the embodiments has been presented for purposes of illustration and description, but is not intended to be exhaustive or limited to the embodiments in the form disclosed. Many modifications and variations will be apparent to those of ordinary skill in the art without departing from the scope and spirit of the invention.

Though the embodiments have been described with reference to certain versions thereof; however, other versions are possible. Therefore, the spirit and scope of the appended claims should not be limited to the description of the preferred versions contained herein.

What is claimed is:

1. A computer-implemented method, comprising:
optimizing a shape for a port tube of a speaker device by varying a portion of a plurality of initial port tube design parameters and iteratively repeating an execution of a simulation computing process that simulates shear measure until the execution of the simulation computing process minimizes the simulated shear measure and outputs a final port tube design for an improved port tube having an optimized central portion and an optimized flare shape of at least one flared exit based on a plurality of final port tube design parameters for an improved shape for the port tube that maximally delays an onset of turbulence and flow separation for improved low frequency output for the speaker device; and
generating the improved port tube using the plurality of final port tube design parameters.

2. The method of claim 1, wherein the plurality final port tube design parameters for the final port tube design define the improved shape for the port tube, nonlinear control is utilized to ensure the optimized central portion and the optimized flare shape for the improved port tube of the speaker device remains below a separation level, and the simulation computing process comprises a linear simulation computing process.

3. The method of claim 2, wherein the initial port tube design parameters and the plurality final port tube design parameters each comprise one or more of port length, minimal cross-sectional area, flare rate, maximal cross-sectional area or parameterization.

4. The method of claim 1, wherein the simulated shear measure is output in the simulation computing process based on a generated graph of simulated air velocities at a center of the port tube and a generated graph of simulated air velocities at adjacent walls of the port tube.

5. The method of claim 1, wherein the simulated shear measure is output by the simulation computing process by adjusting the initial port tube design parameters until the simulation computing process flattens out a simulated velocity contour line at an exit of the at least one flared exit of the port tube.

6. The method of claim 1, wherein the simulated shear measure is output by the simulation computing process by adjusting the initial port tube design parameters until determined port chords and determined velocity vectors in the simulation computing process are aligned in parallel with one another.

7. The method of claim 1, wherein the optimized central portion and the optimized flare shape of the at least one flared exit of the improved port tube avoids pressure inversion along boundaries of the improved port tube and transition to baffle.

8. A non-transitory processor-readable medium that includes a program that when executed by a processor performs a method for optimizing a port tube design, by a computing process, the method comprising:
optimizing, by the processor, a shape for a port tube of a speaker device by varying a portion of a plurality of initial port tube design parameters and iteratively repeating an execution of a simulation computing process that simulates shear measure until the execution of the simulation computing process minimizes the simulated shear measure and outputs a final port tube design for an improved port tube having an optimized central portion and an optimized flare shape of at least one flared exit based on a plurality of final port tube design parameters for an improved shape for the port tube that maximally delays an onset of turbulence and flow separation for improved low frequency output for the speaker device; and
generating the improved port tube using the plurality of final port tube design parameters.

9. The non-transitory processor-readable medium of claim 8, wherein the plurality of final port tube design parameters for the final port tube design define the improved shape for the port tube, nonlinear control is utilized to ensure the optimized central portion and the optimized flare shape for the improved port tube of the speaker device remains below a separation level, and the simulation computing process comprises a linear simulation computing process.

10. The non-transitory processor-readable medium of claim 9, wherein the initial port tube design parameters and the plurality of final port tube design parameters each comprise one or more of port length, minimal cross-sectional area, flare rate, maximal cross-sectional area or parameterization.

11. The non-transitory processor-readable medium of claim 8, wherein the simulated shear measure is output in the simulation computing process based on a generated graph of simulated air velocities at a center of the port tube and a generated graph of simulated air velocities at adjacent walls of the port tube.

12. The non-transitory processor-readable medium of claim 8, wherein the simulated shear measure is output by the simulation computing process by adjusting the initial port tube design parameters until the simulation computing process flattens out a simulated velocity contour line at an exit of the at least one flared exit of the port tube.

13. The non-transitory processor-readable medium of claim 8, wherein the simulated shear measure is output by the simulation computing process by adjusting the initial port tube design parameters until determined port chords and determined velocity vectors in the simulation computing process are aligned in parallel with one another.

14. The non-transitory processor-readable medium of claim 8, wherein the optimized central portion and the optimized flare shape of the at least one flared exit of the improved port tube avoids pressure inversion along boundaries of the improved port tube and transition to baffle.

15. A port tube for a loudspeaker, the port tube comprising:
a body including at least one flared exit and an optimized central portion that is designed by optimization utilizing a simulation computing process for outputting a plurality of final port tube design parameters for the port tube, wherein the port tube structure is based on the plurality of final port tube design parameters from the simulation computing process that comprises:
optimizing a shape for the port tube by varying a portion of a plurality of initial port tube design parameters and iteratively repeating execution of the simulation computing process that simulates shear measure until the execution of the simulation computing process minimizes the simulated shear measure and outputs a final port tube design for the port tube having the optimized central portion and an optimized flare shape of the at least one flared exit based on the plurality of final port tube design parameters for an improved shape for the port tube that maximally delays an onset of turbulence and flow separation for improved low frequency output for the loudspeaker device.

16. The port tube of claim 15, wherein the plurality of final port tube design parameters for the final port tube design define the improved shape for the port tube, nonlinear control is utilized to ensure the optimized central portion and the optimized flare shape for the improved port tube of the loudspeaker remains below a separation level, and the simulation computing process comprises a linear simulation computing process.

17. The port tube of claim 16, wherein the initial port tube design parameters and the plurality of final port tube design parameters each comprise one or more of port length, minimal cross-sectional area, flare rate, maximal cross-sectional area or parameterization.

18. The port tube of claim 15, wherein the simulated shear measure is output in the simulation computing process based on a generated graph of simulated air velocities at a center of the port tube and a generated graph of simulated air velocities at adjacent walls of the port tube.

19. The port tube of claim 15, wherein the simulated shear measure is output by the simulation computing process by adjusting the initial port tube design parameters until the simulation computing process flattens out a simulated velocity contour line at an exit of the at least one flared exit of the port tube.

20. The port tube of claim 15, wherein the simulated shear measure is output by the simulation computing process by adjusting the initial port tube design parameters until determined port chords and determined velocity vectors in the simulation computing process are aligned in parallel with one another, and the optimized central portion and the optimized flare shape of the at least one flared exit of the port tube avoids pressure inversion along boundaries of the port tube and transition to baffle.
